(19) United States
(12) Patent Application Publication
(10) Pub. No.: US 2020/0396664 A1
(43) Pub. Date: Dec. 17, 2020

(54) METHOD OF PERFORMING BEAM FAILURE RECOVERY PROCEDURE AND USER EQUIPMENT

(71) Applicant: NTT DOCOMO, INC., Tokyo (JP)

(72) Inventors: Yuichi Kakishima, Tokyo (JP); Satoshi Nagata, Tokyo (JP); Jing Wang, Beijing (CN); Min Liu, Beijing (CN); Chongning Na, Tokyo (JP); Shohei Yoshioka, Tokyo (JP)

(73) Assignee: NTT DOCOMO, INC., Tokyo (JP)

(21) Appl. No.: 16/968,380

(22) PCT Filed: Feb. 15, 2019
(86) PCT No.: PCT/US2019/018313

§ 371 Date: Aug. 7, 2020

Related U.S. Application Data
(60) Provisional application No. 62/631,400, filed on Feb. 15, 2018.

(51) Int. Cl. H04W 36/06; H04W 36/30; H04W 36/36; H04W 36/00

(52) U.S. Cl. CPC H04W 36/06; H04W 36/0085; H04W 36/36; H04W 36/305

(57) ABSTRACT

A method of performing a beam failure recovery procedure in a user equipment (UE) that includes a Physical (PHY) layer and a Medium Access Control (MAC) layer includes detecting, with the PHY layer, a beam failure for a beam used for communication between the UE and a base station (BS), receiving, with the MAC layer, one or more beam failure instances from the PHY layer, transmitting, from the MAC layer to the PHY layer, a request for a candidate beam based on a number of the beam failure instances, reporting, from the PHY layer to the MAC layer, first beam information that indicates the candidate beam, and causing, with the MAC layer, the PHY layer to transmit, to the BS, a beam failure recovery request that indicates the candidate beam.

### TECHNICAL FIELD

One or more embodiments disclosed herein relate to a method of performing a beam failure recovery procedure in a user equipment (UE) in a wireless communication system.

### BACKGROUND

In a New Radio (NR; fifth generation (5G) radio access technology) system using higher frequency, beamforming technology becomes crucial to achieve sufficient coverage and data rate. In the NR system, a user equipment (UE) communicates with a base station (BS) using a beam selected in a beam management scheme.

For example, when the UE detects a beam failure of the beam used for communicating with the BS, the UE performs a beam failure recovery (BFR) procedure. In the BFR procedure, physical (PHY) and Medium Access Control (MAC) layers of the UE are required to operate in a coordinated manner. However, in the current NR standards, how the PHY and MAC layers should perform functions in the beam recovery procedure has not been determined.

### CITATION LIST

### Non-Patent Reference

[Non-Patent Reference 1] 3GPP, TS 38.211 V 15.0.0

[Non-Patent Reference 2] 3GPP, TS 38.214 V15.0.0

### SUMMARY

Embodiments of the present invention relate to a method of performing a beam failure recovery procedure in a user equipment (UE) including a Physical (PHY) layer and a Medium Access Control (MAC) layer. The method includes detecting, with the PHY layer, a beam failure for a beam used for communication between the UE and a base station (BS), receiving, with the MAC layer, one or more beam failure instances from the PHY layer, transmitting, from the MAC layer to the PHY layer, a request for a candidate beam based on a number of the beam failure instances, reporting, from the PHY layer to the MAC layer, first beam information that indicates the candidate beam, and causing, with the MAC layer, the PHY layer to transmit, to the BS, a beam failure recovery request that indicates the candidate beam.

Embodiments of the present invention relate to a UE that includes a PHY layer and a MAC layer. The UE includes a transceiver that communicates with a BS and a processor that causes the PHY layer to detect a beam failure for a beam used for communication between the UE and the BS. The processor causes the MAC layer to receive one or more beam failure instances from the PHY layer. The processor causes the MAC layer to transmit, to the PHY layer, a request for a candidate beam based on a number of the beam failure instances. The processor causes the PHY layer to report, to the MAC layer, first beam information that indicates the candidate beam. The transceiver transmits, to the BS, a beam failure recovery request that indicates the candidate beam.

Other embodiments and advantages of the present invention will be recognized from the description and figures.

### BRIEF DESCRIPTION OF THE DRAWINGS

FIG. 1 is a diagram showing an example of a configuration of a wireless communication system supporting multi-TRP operations according to one or more embodiments of the present invention.

FIG. 2 is a flowchart diagram showing a beam failure recovery (BFR) procedure in a UE according to one or more embodiments of the present invention.

FIG. 3A is a diagram showing an example operation in the UE in a First Example in accordance with embodiments of the invention.

FIG. 3B is a diagram showing an example operation in the UE in a Second Example in accordance with embodiments of the invention.

FIG. 3C is a diagram showing an example operation in the UE in a Third Example in accordance with embodiments of the invention.

FIG. 3D is a diagram showing an example operation in the UE in a Fourth Example in accordance with embodiments of the invention.

FIG. 4 is a diagram showing a schematic configuration of a TRP according to embodiments of the present invention.

FIG. 5 is a diagram showing a schematic configuration of a UE according to embodiments of the present invention.

### DETAILED DESCRIPTION

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In one or more embodiments of the present invention, a beam may be referred to as a resource or a radio resource.

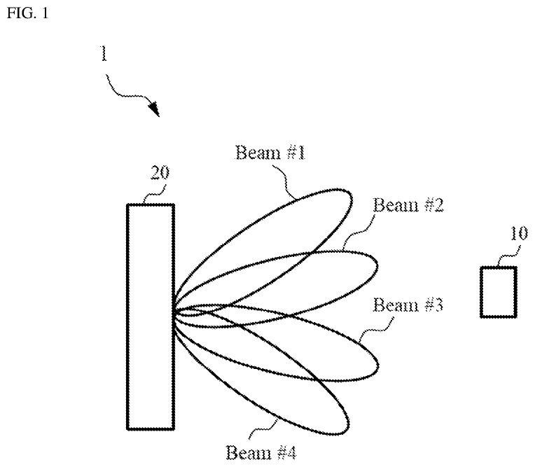

FIG. 1 is a diagram showing an example of a configuration of a wireless communication system according to embodiments of the present invention. As shown in FIG. 1, a wireless communication system 1 includes a UE 10 and a Transmission and Reception Point (TRP) 20. The wireless communication system 1A may be a NR system. The wireless communication system 1A is not limited to the specific configurations described herein and may be any type of wireless communication system such as a Long Term Evolution (LTE)/LTE-Advanced (LTE-A) system.

The TRP 20 may communicate uplink (UL) and downlink (DL) signals with the UE 10 using a beam. The DL and UL signals may include control information and user data. The beam may be referred to as a resource or a radio resource. The TRP 20 may communicate DL and UL signals with the core network through backhaul links. The TRP 20 may be referred to as a base station (BS). The TRP 20 may be referred to as a gNodeB (gNB). For example, when the wireless communications system 1 is an LTE system, the TRP may be an evolved NodeB (eNB). The number of beams is not limited to four as shown in FIG. 1, but the number of beam is not limited thereto. The number of beams for each TRP 20 may be at least one.

The TRP 20 includes antennas, a communication interface to communicate with an adjacent TRP 20 (for example, X2 interface), a communication interface to communicate with the core network (for example, S1 interface), and a Central Processing Unit (CPU) such as a processor or a circuit to process transmitted and received signals with the UE 10. Operations of the TRP 20 may be implemented by the processor processing or executing data and programs stored in a memory. However, the TRP 20 is not limited to the hardware configuration set forth above and may be realized by other appropriate hardware configurations as understood by those of ordinary skill in the art. Numerous TRPs 20 may be disposed to cover a broader service area of the wireless communication system 1.

The UE 10 may communicate DL and UL signals that include control information and user data with the TRP 20. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a Random Access Memory (RAM), a flash memory, and a radio communication device to transmit/receive radio signals to/from the TRP 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below. The UE 10 includes a PHY layer and a MAC layer.

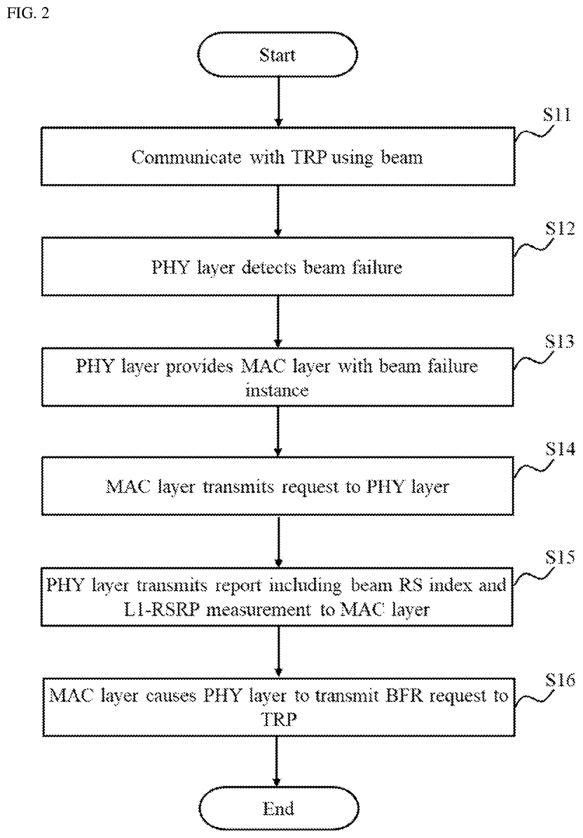

FIG. 2 is a flowchart diagram showing a beam failure recovery (BFR) procedure in the UE 10 according to one or more embodiments of the present invention.

As shown in FIG. 2, at step S11, the UE 10 may communicate with the TRP 20 using a beam. The beam used for the communication may be determined by performing a beam management scheme.

At step S12, a PHY layer of the UE 10 may detect beam failure of the beam when reception quality of signals transmitted using the beam is less than or equal to a predetermined threshold value. The reception quality may be Reference Signal Received Power (RSRP), RSRQ (Reference Signal Received Quality), or Received Signal Strength Indicator (RSSI).

At step S13, the PHY layer may provide a MAC layer of the UE 10 with beam failure instances.

At step S14, when predetermined criteria are met, the MAC layer may transmit, to the PHY layer, a request for a beam Reference Signal (RS) index for a new candidate beam and Layer 1 (L1)-RSRP measurement value. The predetermined criteria will be described below in detail. The beam RS index is an index that identifies each of beams. The L1-RSRP measurement value indicates a measurement value of RSRP measured in the Layer 1 (PHY layer).

At step S15, PHY layer may transmit, to the MAC layer, a report including at least a beam RS index and L1-RSRP measurement value corresponding to the beam RS index in response to the request.

At step S16, the MAC layer may cause the PHY layer to transmit beam failure recovery (BFR) request to the TRP 20.

As described above, according to one or more embodiments of the present invention, at the step S14 of FIG. 2, the MAC layer may transmit the request to the PHY layer when the predetermined criteria are met as shown First to Fifth Examples below. For example, when the predetermined criteria are met, the MAC layer may transmit the request after a predetermined interval. For example, the predetermined interval may be based on a specific timer, a predetermined counter, or a pre-configured time offset. For example, the MAC layer may transmit the request without an interval after the predetermined criteria are met.

In the method of performing the BFR procedure according to one or more embodiments of the present invention, a combination of each of First to Fifth Examples may be applied. Further, in the method of performing the BFR procedure, each of First to Fifth Examples may be applied independently.

### First Example

In a First Example in accordance with embodiments of the invention, when the number of consecutive beam failure instances notified by the PHY layer is greater than or equal to a predetermined threshold value, the MAC layer may transmit the request for the beam RS index and the L1-RSRP measurement value to the PHY layer. For example, the predetermined threshold value is the maximum number of consecutive beam failure instances and is configured by higher layer signaling. For example, the TRP 20 may notify the UE 10 of the predetermined threshold value using Radio Resource Control (RRC) signaling.

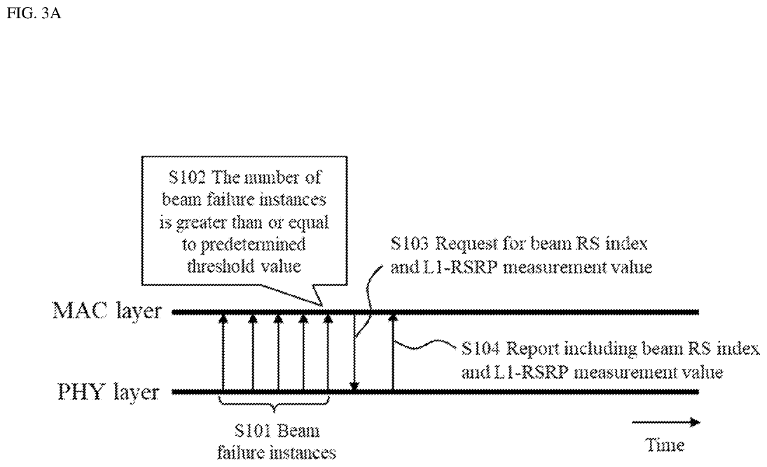

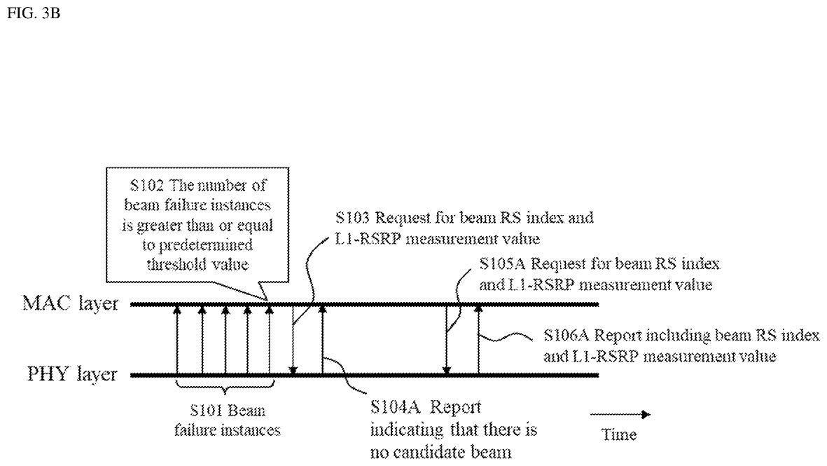

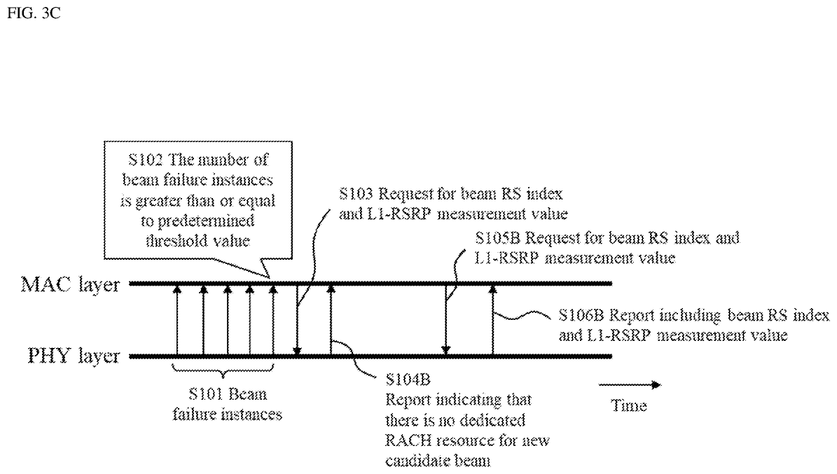

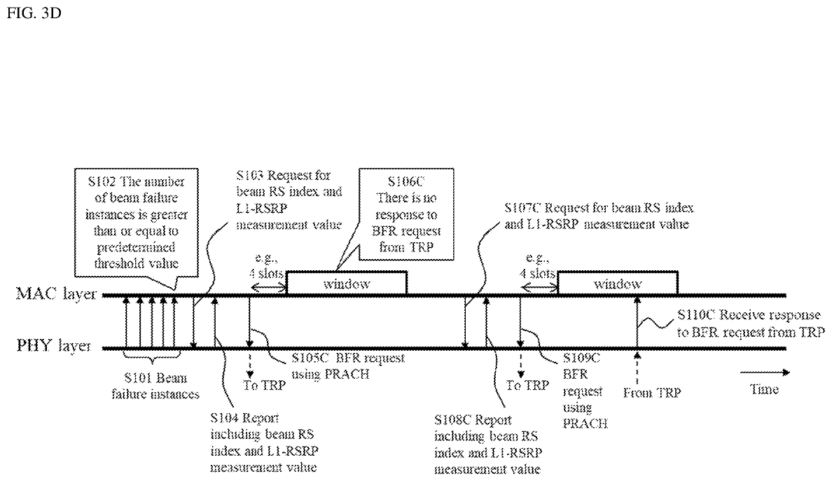

FIG. 3A is a diagram showing an example operation in the UE 10 in a First Example in accordance with embodiments of the invention.

As shown FIG. 3A, at step S101, the PHY layer of the UE 10 may notify the MAC layer of beam failure instances.

At step S102, the MAC layer counts the number of consecutive beam failure instances. When the number of consecutive beam failure instances is greater than or equal to the predetermined threshold value, at step S103, the MAC layer may transmit the request for the beam RS index and the L1-RSRP measurement value to the PHY layer.

At step S104, the PHY layer may transmit a report including the beam RS index for a new candidate beam and the L1-RSRP measurement value corresponding to the new candidate beam.

Furthermore, at the step S103, the MAC layer may transmit the request after the predetermined interval from when the number of consecutive beam failure instances is greater than or equal to the predetermined threshold value. The predetermined interval (e.g., pre-configured time offset) may be set as zero.

Thus, according to one or more embodiments of the present invention, the UE 10 including the PHY layer and the MAC layer performs a beam failure recovery procedure. The PHY layer of the UE 10 detects a beam failure for a beam used for communication between the UE 10 and the TRP 20. The MAC layer of the UE 10 receives one or more beam failure instances from the PHY layer. The MAC layer transmits, to the PHY layer, a request for a candidate beam based on the number of the beam failure instances. The PHY layer reports, to the MAC layer, first beam information that indicates the candidate beam. The MAC layer causes the PHY layer to transmit a beam failure recovery request that indicates the candidate beam, to the TRP 20.

According to one or more embodiments of the present invention, the MAC layer transmits the request when the number of beam failure instances is greater than or equal to the maximum number of the beam failure instances. The maximum number may be notified by the BS using the RRC signaling.

According to one or more embodiments of the present invention, the MAC layer transmits the request after a predetermined interval. The predetermined interval may be based on a specific timer, a counter that counts the number of beam failure instances, or a pre-configured time offset.

According to one or more embodiments of the present invention, the first beam information indicates a L1-RSRP measurement value of the candidate beam in addition to an index that identifies each candidate beam. For example, the L1-RSRP measurement value is greater than a predetermined threshold value. For example, the PHY layer reports multiple sets of the candidate beam and the L1-RSRP measurement value in one shot. As another example, the PHY layer reports multiple sets of the candidate beam and the L1-RSRP measurement value in multiple shots.

### Second Example

In a Second Example in accordance with embodiments of the invention, when there is no candidate beam in the last report from the PHY layer, the MAC layer may transmit the request for the beam RS index and the L1-RSRP measurement value to the PHY layer. For example, when the reception quality (e.g., L1-RSRP measurement value) for each of the candidate beams is less than predetermined quality, the PHY may determine that there is no candidate beam. As another example, PHY layer may transmit candidate beam information but MAC may determine the candidate beam is not appropriate.

FIG. 3B is a diagram showing an example operation in the UE 10 in the Second Example in accordance with embodiments of the invention. Similar steps in FIG. 3B to steps in FIG. 3A have the same reference label.

As shown in FIG. 3B, at step S104A, in response to the request from the MAC layer, the PHY layer of the UE 10 may transmit a report indicating that there is no candidate beam to the MAC layer.

Then, at step S105A, the MAC layer may transmit the request for the beam RS index and the L1-RSRP measurement value to the PHY layer based on reception of the report indicating that there is no candidate beam.

At step S106A, the PHY layer may transmit a report including the beam RS index for a new candidate beam and the L1-RSRP measurement value corresponding to the new candidate beam.

Thus, in the Second Example in accordance with embodiments of the invention, the report indicating that there is no candidate beam from the PHY layer may trigger the request from the MAC.

According to one or more embodiments of the present invention, the MAC layer transmits, to the PHY layer, a request for a candidate beam based on the number of the beam failure instances. Then, the PHY layer reports, to the MAC layer, first beam information that indicates the candidate beam. Further, the PHY layer reports, to the MAC layer, second beam information before the first beam information is reported. The MAC layer transmits the request when the second beam information does not include a candidate beam.

### Third Example

In a Third Example in accordance with embodiments of the invention, when there is no Physical Random Access Channel (PRACH) resource associated with the new candidate beam in the last report from the PHY layer, the MAC layer may transmit the request for the beam RS index and the L1-RSRP measurement value to the PHY layer.

FIG. 3C is a diagram showing an example operation in the UE 10 in the Third Example in accordance with embodiments of the invention. Similar steps in FIG. 3C to steps in FIG. 3A have the same reference label.

As shown in FIG. 3C, at step S104B, in response to the request from the MAC layer, the PHY layer of the UE 10 may transmit a report indicating that there is no dedicated RACH resource for the new candidate beam to the MAC layer.

Then, at step S105B, the MAC layer may transmit the request for the beam RS index and the L1-RSRP measurement value to the PHY layer based on reception of the report indicating that there is no candidate beam.

At step S106B, the PHY layer may transmit a report including the beam RS index for a new candidate beam and the L1-RSRP measurement value corresponding to the new candidate beam.

Thus, in the Third Example in accordance with embodiments of the invention, the report indicating that there is no dedicated RACH resource for the new candidate beam from the PHY layer may trigger the request from the MAC.

According to one or more embodiments of the present invention, the MAC layer transmits, to the PHY layer, a request for a candidate beam based on the number of the beam failure instances. Then, the PHY layer reports, to the MAC layer, first beam information that indicates the candidate beam. Further, the PHY layer reports, to the MAC layer, second beam information before the first beam information is reported. The MAC layer transmits the request when the second beam information include a candidate beam that is not associated with a PRACH resource.

### Fourth Example

In a Fourth Example in accordance with embodiments of the invention, when the MAC layer of the UE 10 does not receive, from the TRP 20, a response to a BFR request within a window, the MAC layer may transmit the request for the beam RS index and the L1-RSRP measurement value to the PHY layer.

FIG. 3D is a diagram showing an example operation in the UE 10 in the Fourth Example in accordance with embodiments of the invention. Similar steps in FIG. 3D to steps in FIG. 3A have the same reference label.

As shown in FIG. 3D, at step S105C, when the MAC layer receives the report indicating the beam RS index for a new candidate beam and the L1-RSRP measurement value, the MAC layer may transmit the BFR request using the PRACH.

At step S106C, the MAC layer may not receive, from the TRP 20, any response to the BFR request within a window. The window may have a predetermined size. For example, the window starts after a predetermined slot (e.g., 4 slots). Then, at step S107C, the MAC layer may transmit the request for the beam RS index and the L1-RSRP measurement value to the PHY layer.

At step S108C, the PHY layer may transmit a report including the beam RS index for a new candidate beam and the L1-RSRP measurement value corresponding to the new candidate beam.

At step S109C, when the MAC layer receives the report indicating the beam RS index for a new candidate beam and the L1-RSRP measurement value, the MAC layer may transmit the BFR request using the PRACH.

At step S110, the MAC layer may receive, from the TRP 20, a response to the BFR request within a window.

Thus, in the Fourth Example in accordance with embodiments of the invention, the request from the MAC may be triggered when there is no response to the BFR request from the TRP.

According to one or more embodiments of the present invention, the MAC layer transmits, to the PHY layer, a request for a candidate beam based on the number of the beam failure instances. Then, the PHY layer reports, to the MAC layer, first beam information that indicates the candidate beam. For example, the MAC layer transmits the request when the MAC layer does not receive a response from the TRP 20 within a window via the PHY layer.

The response from the TRP 20 indicates a TRP 20's response for the BFR request from the UE 10. If it is monitored by the UE 10, beam recovery is successful.

In this method, after the normal/successful MAC layer transmits a request to the PHY layer and the PHY layer reports a new candidate beam, the UE 10 may transmit the BFR request (i.e., PRACH resource associated with the new candidate beam) to the TRP 20 in the BFR procedure. Then, the UE 10 may monitor the response from the TRP 20 to indicate the successful BFR. If the UE 10 does not monitor the response from the TRP 20, the UE 10 may assume that the BFR is failed. There may be many reasons for the failure. According to one or more embodiments of the present invention, the UE 10 may assume that the reason of failure is not a proper new beam. Therefore, at the UE 10, the MAC layer may request a new candidate beam again.

### Fifth Example

In a Fifth Example in accordance with embodiments of the invention, when a predetermined timer for transmitting the request is expired, the MAC layer may always transmit the request to the PHY layer. For example, in the Fifth Example in accordance with embodiments of the invention, the MAC layer may periodically transmit the request to the PHY layer. For example, the periodicity of the transmission of the request may be determined based on the shortest periodicity of candidate beam identification RS. The candidate beam identification RS is used for measurement for new candidate beam identification. The candidate beam identification RS may be a Channel State Information-Reference Signal (CSI-RS) or a Synchronization Signal Block (SSB).

Next, examples of a format of the request for the beam RS index and the L1-RSRP measurement value will be described below.

The format of the request may indicate contents of the report from the PHY layer.

For example, the format of the request includes one state indicating whether the request is valid. For example, the format of the request includes the indication indicating that the MAC layer requests new candidate beam information for the PHY layer.

For example, the format of the request includes two states indicating whether the request is valid. When one bit is used in the format, “0” indicates that the MAC layer does not request new candidate beam information from the PHY layer. The new candidate beam information includes at least a set of the beam RS index and the L1-RSRP measurement value. The number of sets may be the number of new candidate beams (beam RS indexes) included in the report from the PHY layer. “1” indicates that the MAC layer requests the new candidate beam information from the PHY layer. The maximum number of sets included in the new candidate beam information may be pre-defined in the NR standards/specification. For example, the maximum number of sets may be configured by the RRC signaling. For example, the maximum number of sets may be determined based on UE capability/implementation so that it is not necessary to be defined or configured.

In a case where the format of the request includes two states indicating whether the request is valid, when the PHY layer receives the request indicating “0”, the PHY layer does not transmit the report to the MAC layer.

On the other hand, when the PHY layer receives the request indicating “1”, if there is no beam that meets criteria of the L1-RSRP (for example, the L1-RSRP measurement value of each beam is less than a L1-RSRP measurement threshold value), the PHY layer may not transmit the report or may transmit the report indicating a special state, e.g., {0000, 00000} to the MAC layer.

When the PHY layer receives the request indicating “1”, if there is at least a beam that meets criteria of the L1-RSRP (for example, the L1-RSRP measurement value of each beam is greater than or equal to a L1-RSRP measurement threshold value), the PHY layer may transmit the report indicating K sets of {beam RS index, L1-RSRP measurement} that meet the criteria of the L1-RSRP. For example, the value of K may be pre-defined in the NR/standards/specification. For example, the value of K may be configured by the RRC signaling. That is, the TRP 20 may notify the UE 10 of K using the RRC signaling. For example, the value of K may be based on UE capability/implementation, e.g., K may be the total number of beams that meet the criteria of the L1-RSRP. For example, the value of K may vary depending on L1-RSRP measurement. Furthermore, the above examples may be combined. For example, the value of K is based on UE capability/implementation and limited by a higher layer parameter maximum set number as M_max, e.g., K is total number of beams that meets the criteria of the L1-RSRP, while K>M_max, the PHY layer may transmits the report M_max sets of {beam RS index, L1-RSRP measurement} to the MAC layer.

For example, the format of the request includes multiple states indicating the contents of the report from the PHY layer. When two bits are used in the format, “00” indicates that the MAC layer does not request the new candidate beam information from the PHY layer. “01” indicates that the MAC layer requests the new candidate beam information including one set of the beam RS index and the L1-RSRP measurement value from the PHY layer. “10” indicates that the MAC layer requests the new candidate beam information including at least a set of the beam RS index and the L1-RSRP measurement value from the PHY layer. The maximum number of sets included in the new candidate beam information may be pre-defined in the NR standards/specification. For example, the maximum number of sets may be pre-configured by the RRC signaling. For example, the maximum number of sets may be determined based on UE capability/implementation so that it is not necessary to be defined or configured.

As another example of the format of the request including multiple states indicating the contents of the report from the PHY layer, for example, “00” the MAC layer does not request new candidate beam information from the PHY layer. “01” indicates that the MAC layer requests the new candidate beam information including one set of the beam RS index and the L1-RSRP measurement value from the PHY layer. “10” indicates that the MAC layer requests up to ‘X’ sets of the beam RS index and the L1-RSRP measurement value from the PHY layer. “11” indicates that the MAC layer requests up to ‘Y’ sets of the beam RS index and the L1-RSRP measurement value from the PHY layer. The number ‘X’ and ‘Y’ may be pre-configured by the RRC signaling, pre-defined in the NR standards/specification, or determined based on L1-RSRP measurement.

As another example of the format of the request including multiple states indicating the contents of the report from the PHY layer, for example, “00” indicates that the MAC layer does not request the new candidate beam information from the PHY layer. “01” indicates that the MAC layer requests at least a beam RS index only of the new candidate beams from the PHY layer. “10” indicates that the MAC layer requests at least a L1-RSRP measurement value only of the new candidate beams from the PHY layer. The L1-RSRP measurement value may be corresponding to the beam RS index with predetermined rules, e.g., the beam RS index in the last report by the same order. “11” indicates that the MAC layer requests one or more set new candidate beam information including beam index and L1-RSRP from the PHY layer.

The format of the request may indicate a report mode from the PHY layer. The PHY layer may not transmit the report or may transmit the reporting including a special state, e.g., {0000, 00000} to MAC when there is no beam that meets the criteria of the L1-RSRP (for example, the L1-RSRP measurement value of each beam is less than the threshold value of the L1-RSRP measurement). The report mode may be a time domain behavior of the report is pre-defined. The report mode may be pre-defined in the NR standards/specification. The report mode may be pre-configured by the RRC signaling. The report mode may be indicated by the request from the MAC layer. For example, the report mode includes one-shot report and multi-shot report modes.

In the one-shot report mode, the PHY layer provides the MAC layer with one or more sets of {beam RS index, L1-RSRP measurement} that meet the criteria of the L1-RSRP (e.g., threshold value of the L1-RSRP measurement) upon the MAC layer requests in one slot.

In the multi-shot report mode, the PHY layer provides the MAC layer with one or more sets of {beam RS index, L1-RSRP measurement} that meet the criteria of the L1-RSRP (e.g., threshold value of the L1-RSRP measurement) upon the MAC layer requests in multiple slots. In the multi-shot report mode, the reporting interval and the number of reports (or the reporting interval and the duration for multi-shot report) may be configured by the RRC signaling.

In the format of the request indicating the report mode, for example, “0” indicates the MAC layer requests PHY to provide one or more sets of {beam RS index, L1-RSRP measurement} that meet the criteria of the L1-RSRP in one slot. “1” indicates the MAC layer requests the PHY layer to provide one or more sets of {beam RS index, L1-RSRP measurement} that meet the criteria of the L1-RSRP in multiple slots. The number of transmission interval may be identical to the number of beams reported.

The format of the request may designate multiple states indicating both of the report mode and the contents of the report. For example, when the two bits is used in the format, “00” indicates that the MAC layer does not request new candidate beam information from the PHY layer. “01” indicates that the MAC layer requests up to ‘X’ sets of the beam RS index and the L1-RSRP measurement value from the PHY layer and the PHY layer provides the new candidate beam information including the ‘X’ sets of the beam RS index and the L1-RSRP measurement value in one shot. “10” indicates that the MAC layer requests up to ‘X’ sets from the PHY layer, the PHY layer provides the new candidate beam information including the ‘X’ sets in multiple shots. The number of ‘X’ may be pre-configured by the RRC signaling or pre-defined in the NR standards/specification.

In a case where the format designates 4 states indicating the contents of the request and the report mode, when the PHY layer receives the request including “00”, the PHY layer does not transmit the report including the new candidate beam information. When the PHY layer receives the request including “01”, the PHY layer reports the new candidate beam information including one set of the beam RS index and the L1-RSRP measurement value and provides the one set in each of ‘M’ slots during a predetermined period. When the PHY layer receives the request including “10”, the PHY layer reports the new candidate beam information including up to ‘X’ sets and provides the ‘X’ sets in one shot. When the PHY layer receives the request including “11”, the PHY layer reports the new candidate beam information including up to ‘X’ sets and provides the ‘X’ sets in each of ‘M’ slots during a predetermined period. The values of ‘X’ and ‘M’ may be pre-configured by the RRC signaling or pre-defined in the NR standards/specification.

(Configuration of TRP)

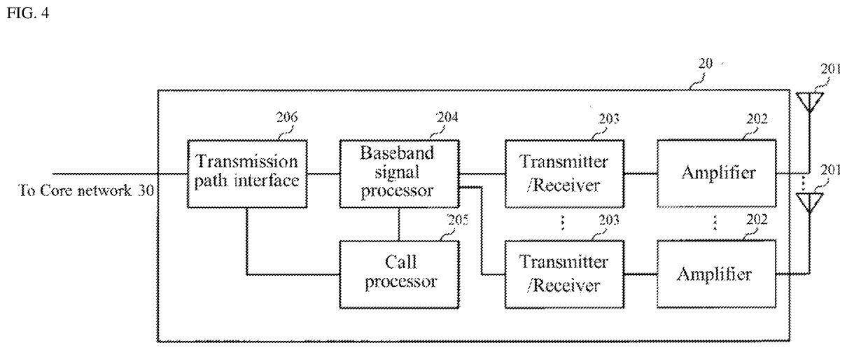

The TRP 20 according to embodiments of the present invention will be described below with reference to FIG. 4. FIG. 4 is a diagram illustrating a schematic configuration of the TRP 20 according to embodiments of the present invention. The TRP 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the TRP 20 to the UE 20 is input from the core network, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., Radio Resource Control (RRC) signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the TRP 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network through the transmission path interface 206. The call processor 205 performs call processing such as setting up and releasing a communication channel, manages the state of the TRP 20, and manages the radio resources.

(Configuration of UE)

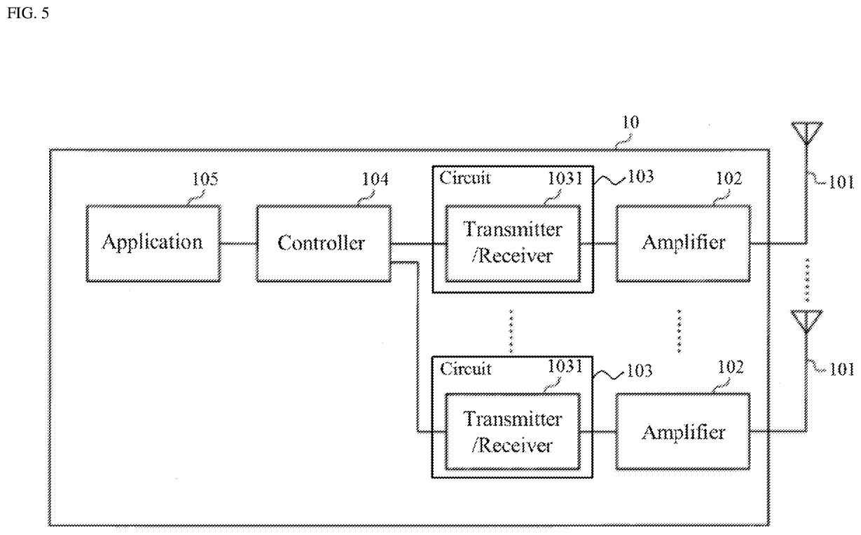

The UE 10 according to embodiments of the present invention will be described below with reference to FIG. 5. FIG. 5 is a schematic configuration of the UE 10 according to embodiments of the present invention. The UE 10 has a plurality of UE antenna S101, amplifiers 102, the circuit 103 comprising transceiver (transmitter/receiver) 1031, the controller 104, and an application 105.

As for DL, radio frequency signals received in the UE antenna S101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

### Another Example

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method of performing a beam failure recovery procedure in a user equipment (UE) that comprises a Physical (PHY) layer and a Medium Access Control (MAC) layer, the method comprising:
detecting, with the PHY layer, a beam failure for a beam used for communication between the UE and a base station (BS);
receiving, with the MAC layer, one or more beam failure instances from the PHY layer;
transmitting, from the MAC layer to the PHY layer, a request for a candidate beam based on a number of the beam failure instances;
reporting, from the PHY layer to the MAC layer, first beam information that indicates the candidate beam; and
causing, with the MAC layer, the PHY layer to transmit, to the BS, a beam failure recovery request that indicates the candidate beam.

2. The method according to claim 1,
wherein the transmitting transmits the request when the number of beam failure instances is a maximum number of the beam failure instances, and
wherein the maximum number is notified by the BS using Radio Resource Control (RRC) signaling.

3. The method according to claim 1,
wherein the transmitting transmits the request after a predetermined interval, and
wherein the predetermined interval is based on a specific timer, a counter that counts the number of beam failure instances, or a pre-configured time offset.

4. The method according to claim 1, further comprising:
reporting, from the PHY layer to the MAC layer, second beam information before the first beam information is reported,
wherein the transmitting transmits the request when the second beam information does not include a candidate beam.

5. The method according to claim 1, further comprising:
reporting, from the PHY layer to the MAC layer, second beam information before the first beam information is reported,
wherein the transmitting transmits the request when the second beam information include a candidate beam that is not associated with a Physical Random Access Channel (PRACH) resource.

6. The method according to claim 1, wherein the transmitting transmits the request when the MAC layer does not receive a response from the BS within a window via the PHY layer.

7. The method according to claim 1,
wherein the transmitting transmits the request with a predetermined periodicity,
wherein the predetermined periodicity is determined based on the shortest periodicity of a reference signal (RS), and
wherein the RS is used for measurement for new candidate beam identification.

8. The method according to claim 1, wherein a format of the request indicates at least one of contents of a report from the PHY layer and a report mode.

9. The method according to claim 1, wherein the reporting does not report, to the MAC layer, the first beam information when there is no candidate beam that meets criteria of Layer 1-Referesnce Signal Received Power (L1-RSRP) measurement.

10. The method according to claim 1, the first beam information indicates a L1-RSRP measurement value of the candidate beam.

11. The method according to claim 11, the L1-RSRP measurement value is greater than a predetermined threshold value.

12. The method according to claim 11, wherein the reporting reports multiple sets of the candidate beam and the L1-RSRP measurement value in one shot.

13. The method according to claim 11, wherein the reporting reports multiple sets of the candidate beam and the L1-RSRP measurement value in multiple shots.

14. The method according to claim 14, further comprising:
receiving, with the PHY layer, a reporting interval of the multiple shots and a number of the multiple shorts are reporting from the BS by RRC signaling.

15. A user equipment (UE) that comprises a Physical (PHY) layer and a Medium Access Control (MAC) layer, the UE comprising:
a transceiver that communicates with a base station (BS); and
a processor that causes the PHY layer to detect a beam failure for a beam used for communication between the UE and the BS,
wherein the processor causes the MAC layer to receive one or more beam failure instances from the PHY layer,
wherein the processor causes the MAC layer to transmit, to the PHY layer, a request for a candidate beam based on a number of the beam failure instances,
wherein the processor causes the PHY layer to report, to the MAC layer, first beam information that indicates the candidate beam, and
wherein the transceiver transmits, to the BS, a beam failure recovery request that indicates the candidate beam.

16. The UE according to claim 15,
wherein the processor causes the MAC layer to transmit the request when the number of beam failure instances is greater than or equal to a maximum number of the beam failure instances, and
wherein the maximum number is notified by the BS using Radio Resource Control (RRC) signaling.

17. The UE according to claim 15,
wherein the processor causes the MAC layer to transmit the request after a predetermined interval, and
wherein the predetermined interval is based on a specific timer, a counter that counts the number of beam failure instances, or a pre-configured time offset.
